(19) United States
(12) Patent Application Publication
(10) Pub. No.: US 2017/0374578 A1
(43) Pub. Date: Dec. 28, 2017

(54) MOBILITY CONTROL IN DUAL CONNECTIVITY OPERATION MODE

(71) Applicant: Nokia Solutions and Networks Oy, Espoo (FI)

(72) Inventors: Srinivasan SELVAGANAPATHY, Bangalore (IN); Seppo Ilmari VESTERINEN, Oulunsalo (FI); Xiang XU, Nanjing (CN)

(21) Appl. No.: 15/544,511

(22) PCT Filed: Feb. 9, 2015
(86) PCT No.: PCT/EP2015/052599

§ 371 Date: Jul. 18, 2017

(51) Int. Cl. H04W 28/02; H04W 28/08; H04W 76/04; H04W 60/06; H04W 8/08; H04W 88/06; H04W 76/02

(52) U.S. Cl. CPC H04W 28/0226; H04W 28/08; H04W 76/041; H04W 76/025; H04W 8/082; H04W 28/0252; H04W 88/06; H04W 60/06

(57) ABSTRACT

An apparatus comprising at least one processing circuitry, and at least one memory for storing instructions to be executed by the processing circuitry, wherein the at least one memory and the instructions are configured to, with the at least one processing circuitry, cause the apparatus at least: to determine whether a bearer to be set up and used for a communication connection of a communication element is a bearer eligible for selected traffic offloading to a local gateway of a cell group when the local gateway is available, and in case the determination is affirmative, to provide an indication in a signaling to a communication network control element of the communication element, the indication indicates that the bearer to be set up is a bearer eligible for selected traffic off-loading as soon as a local gateway is available.

### BACKGROUND

### Field

The present invention relates to apparatuses, methods, systems, computer programs, computer program products and computer-readable media usable for mobility control in dual connectivity operation mode.

### Background Art

The following description of background art may include insights, discoveries, understandings or disclosures, or associations, together with disclosures not known to the relevant prior art, to at least some examples of embodiments of the present invention but provided by the invention. Some of such contributions of the invention may be specifically pointed out below, whereas other of such contributions of the invention will be apparent from the related context.

The following meanings for the abbreviations used in this specification apply:
3GPP 3^{rd} Generation Partnership Project
APN: access point name
BS: base station
CN: core network
CPU: central processing unit
eNB: evolved node B
ERAB: E-UTRAN radio access bearer
E-UTRAN: evolved UMTS terrestrial radio access network
GW: gateway
ID: identification, identifier
IP: Internet protocol
LGW: local gateway
LTE: Long Term Evolution
LTE-A: LTE Advanced
MCG: master cell group
MeNB: master eNB
MME: mobility management element
NAS: non-access stratum
PDN: packet data network
PDP: packet data protocol
PDU: packet data unit
PGW: packet data network gateway
RAB: radio access bearer
RCR: reconfiguration
RRC: radio resource control
S-TMSI: SAE temporary mobile subscriber identity
SAE: system architecture evolution
SCG: secondary cell group
SeNB: secondary eNB
SGW: serving gateway
SIPTO: selected IP traffic offloading
SIPTO@LN: SIPTO at local network
UE: user equipment
UMTS: universal mobile telecommunication system
VNF: virtual network function

Embodiments of the present invention are related to a communication system in which a suitable architecture, procedure and protocol are provided with regard to a functionality allowing a suitable mobility control for a communication element like a UE in a dual connectivity operation mode.

### SUMMARY

According to an example of an embodiment, there is provided, for example, an apparatus comprising at least one processing circuitry, and at least one memory for storing instructions to be executed by the processing circuitry, wherein the at least one memory and the instructions are configured to, with the at least one processing circuitry, cause the apparatus at least: to determine whether a bearer to be set up and used for a communication connection of a communication element is a bearer eligible for selected traffic offloading to a local gateway of a cell group when the local gateway is available, and in case the determination is affirmative, to provide an indication in a signaling to a communication network control element of the communication element, the indication indicates that the bearer to be set up is a bearer eligible for selected traffic offloading as soon as a local gateway is available.

Furthermore, according to an example of an embodiment, there is provided, for example a method comprising determining whether a bearer to be set up and used for a communication connection of a communication element is a bearer eligible for selected traffic offloading to a local gateway of a cell group when the local gateway is available, and in case the determination is affirmative, providing an indication in a signaling to a communication network control element of the communication element, the indication indicates that the bearer to be set up is a bearer eligible for selected traffic offloading as soon as a local gateway is available.

According to further refinements, these examples may include one or more of the following features:
for determining whether the bearer is a bearer eligible for selected traffic offloading to the local gateway, subscriber information and policy information related to the communication element requesting a bearer setup may be used;
the indication may be provided in a bearer release signaling as a cause value informing that the bearer release is triggered for the selected traffic offloading;
the indication may be provided in a bearer setup signaling;
a bearer modification message including information about the target cell group and the local gateway included in the target cell group may be received and processed, it may be determined whether there is only one bearer available for the communication element, in case the determination results that there is only one bearer available, a detach procedure for the communication element for moving the bearer may be triggered, and information related to a temporary mobile subscriber identity may be provided to the communication network control element of the communication element;
by initiating a packet data protocol context reactivation, an immediate offloading of the bearer eligible for selected traffic offloading may be triggered when it is detected that a local gateway is available in a target cell group to which at least a part of a communication conducted by the communication element is switchable;
a bearer modification message including information about the target cell group and the local gateway included in the target cell group may be received and processed, and a bearer release may be triggered by providing a signaling including a packet data protocol context deactivation instruction comprising a context reactivation indication, wherein an information may be included in the signaling, which indicates that the context reactivation is triggered for moving the bearer to the local gateway;
a signaling related to an activation of a packet data protocol context for a bearer eligible for selected traffic offloading to a local gateway may be received and processed, wherein the signaling may include address information of the target cell group, a connection to a communication network control element associated to the target cell group may be established for setting up a context with the local gateway of the target cell group, and a correlation identification element of the local gateway may be received and processed;
a bearer setup to the target cell group may be initiated by using the correlation identification element;
the target cell group may comprise a secondary cell group, and a source cell group from which at least a part of a communication conducted by the communication element is to be switched may comprise one of a master cell group and a secondary cell group;
the processing may be implemented in a management network control element acting as a mobility management element or function, wherein the at least one communication element may include at least one of a terminal device or user equipment whose communication is controlled by a communication network control element comprising an evolved node B of an Long Term Evolution or Long Term Evolution-Advanced communication system.

According to an example of an embodiment, there is provided, for example, an apparatus including at least one processing circuitry, and at least one memory for storing instructions to be executed by the processing circuitry, wherein the at least one memory and the instructions are configured to, with the at least one processing circuitry, cause the apparatus at least: to receive and store, in case a bearer is to be set up and used for a communication connection of a communication element, an indication in a signaling from a management control element, wherein the indication indicates that the bearer to be set up is a bearer eligible for selected traffic offloading as soon as a local gateway is available, and to process the indication in a control procedure for controlling a movement of at least one bearer of the communication element from a source cell group to a target cell group.

Furthermore, according to an example of an embodiment, there is provided, for example a method including receiving and storing, in case a bearer is to be set up and used for a communication connection of a communication element, an indication in a signaling from a management control element, wherein the indication indicates that the bearer to be set up is a bearer eligible for selected traffic offloading as soon as a local gateway is available, and processing the indication in a control procedure for controlling a movement of at least one bearer of the communication element from a source cell group to a target cell group.

According to further refinements, these examples may include one or more of the following features:
the indication may be received in a bearer release signaling as a cause value informing that the bearer release is triggered for the selected traffic offloading;
the indication may be received in a bearer setup signaling;
for processing the indication in the control procedure for controlling a movement of at least one bearer of the communication element from the source cell group to the target cell group, it may be detected that the communication element to which the bearer belongs is communicating with a target cell group supporting a local gateway being usable for selected traffic offloading, and it may be determined that a bearer to be set up for the target cell group corresponds to the bearer for selected traffic offloading being indicated in the stored indication;
an addition procedure for adding the target cell group without bearer setup to the target cell group may be executed, and a transmission to the management control element of a bearer modification message comprising information about the target cell group and the local gateway supported thereby may be caused;
a bearer release signaling including a packet data protocol context deactivation instruction comprising a context reactivation indication may be received and processed, wherein an information may be included in the signaling, which indicates that the context reactivation is triggered for moving the bearer to the local gateway, and a transmission of a message to the communication element including information regarding the addition of the target cell group and the release of the bearer may be caused;
it may be determined whether the target cell group without bearer setup is to be kept for a configured duration on the basis of the information included in the signaling;
a transmission to the management control element of a bearer modification message indicating a need for a packed data protocol context reactivation may be caused, the message comprising information about an address of the local gateway supported by the target cell group;
a bearer release signaling including a packet data protocol context deactivation instruction comprising a context reactivation indication may be received and processed, wherein an information may be included in the signaling, which indicates that the context reactivation is triggered for moving the bearer to the local gateway, and transmission of a message to the communication element including information regarding the release of the bearer may be caused, wherein a connection to the target cell group associated with a previous connection may be kept;
the target cell group may be selected on the basis of an inter-frequency measurement result;
in case both the target cell group and the source cell group are secondary cell groups with a local gateway, the bearer eligible for selected traffic offload at the source cell group when the target cell group is added may be released;
transmission of a signaling related to an activation of a packet data protocol context for a bearer eligible for selected traffic offloading to a local gateway may be caused, wherein the signaling may include address information of the target cell group;
a bearer setup signaling for initiation of a setup of a bearer to the target cell group may be received and processed, the signaling including a correlation identification element of the local gateway, a bearer setup procedure to the target cell group may be conducted, wherein information including the correlation identification element may be provided to the target cell group, and the communication element may be informed about the addition of the bearer to the local gateway;
the target cell group may comprise a secondary cell group, and a source cell group from which at least a part of a communication conducted by the communication element is to be switched may comprise one of a master cell group and a secondary cell group;
the processing may be implemented in a communication network control element controlling a communication of at least one communication element including at least one of a terminal device or user equipment, wherein the communication network control element may comprise an evolved node B of an Long Term Evolution or Long Term Evolution-Advanced communication system.

In addition, according to embodiments, there is provided, for example, a computer program product for a computer, including software code portions for performing the steps of the above defined methods, when said product is run on the computer. The computer program product may include a computer-readable medium on which said software code portions are stored. Furthermore, the computer program product may be directly loadable into the internal memory of the computer and/or transmittable via a network by means of at least one of upload, download and push procedures.

### BRIEF DESCRIPTION OF THE DRAWINGS

Some embodiments of the present invention are described below, by way of example only, with reference to the accompanying drawings, in which:

FIG. 1 shows a diagram illustrating a general architecture of a communication system where some examples of embodiments are implementable;

FIGS. 2a, 2b and 2c show diagrams illustrating a types of bearers available in a dual connectivity operation mode where some examples of embodiments are applicable;

FIG. 3 shows a signaling diagram illustrating an example of a mobility control processing;

FIG. 4 shows a signaling diagram illustrating a mobility control processing according to some examples of embodiments;

FIG. 5 shows a signaling diagram illustrating a mobility control processing according to some examples of embodiments;

FIG. 6 shows a signaling diagram illustrating a mobility control processing according to some examples of embodiments;

FIG. 7 shows a signaling diagram illustrating a mobility control processing according to some examples of embodiments;

FIG. 8 shows a flow chart of a processing conducted in a management control element or function according to some examples of embodiments;

FIG. 9 shows a flow chart of a processing conducted in a communication network control element or function according to some examples of embodiments;

FIG. 10 shows a diagram of a network element acting as a management control element or function according to some examples of embodiments; and

FIG. 11 shows a diagram of a communication network control element according to some examples of embodiments.

### DESCRIPTION OF EMBODIMENTS

In the last years, an increasing extension of communication networks, e.g. of wire based communication networks, such as the Integrated Services Digital Network (ISDN), DSL, or wireless communication networks, such as the cdma2000 (code division multiple access) system, cellular 3rd generation (3G) like the Universal Mobile Telecommunications System (UMTS), and fourth generation (4G) communication networks or enhanced communication networks based e.g. on LTE or LTE-A, cellular 2nd generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the 3rd Generation Partnership Project (3GPP), Telecoms & Internet converged Services & Protocols for Advanced Networks (TISPAN), the International Telecommunication Union (ITU), 3rd Generation Partnership Project 2 (3GPP2), Internet Engineering Task Force (IETF), the IEEE (Institute of Electrical and Electronics Engineers), the WiMAX Forum and the like are working on standards or specifications for telecommunication network and access environments.

Embodiments as well as principles described below are applicable to any communication network control element or management control element or function, such as a network element, a relay node, a server, a node, a corresponding component, and/or to any communication system or any combination of different communication systems that support required functionalities. The communication system may be a fixed communication system, a wireless communication system or a communication system utilizing both fixed network parts and wireless network parts. The protocols being used, the specifications of communication systems, apparatuses, such as nodes, servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on 3GPP standards, such as a third generation or fourth generation (like LTE or LTE-A) communication network, without restricting the embodiments to such an architecture, however. It is obvious for a person skilled in the art that the embodiments may also be applied to other kinds of communications networks having suitable means by adjusting parameters and procedures appropriately, e.g. WLAN or WiFi, worldwide interoperability for microwave access (WiMAX), Bluetooth®, personal communications services (PCS), ZigBee®, wideband code division multiple access (WCDMA), systems using ultra-wideband (UWB) technology, sensor networks, and mobile ad-hoc networks (MANETs).

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules etc. that have not been specifically mentioned.

A basic system architecture of a communication system where examples of embodiments are applicable may include an architecture of one or more communication networks including a wired or wireless access network subsystem and a core network. Such an architecture may include one or more communication network control elements, access network elements, radio access network elements, access service network gateways or base transceiver stations, such as a base station (BS), an access point or an eNB, which control a respective coverage area or cell(s) (also referred to as a cell group) and with which one or more communication elements, user devices or terminal devices, such as a UE, or another device having a similar function, such as a modem chipset, a chip, a module etc., which can also be part of an element, function or application capable of conducting a communication, such as a UE, an element or function usable in a machine to machine or device to device communication architecture, or attached as a separate element to such an element, function or application capable of conducting a communication, or the like, are capable to communicate via one or more channels for transmitting several types of data. Furthermore, core network elements such as gateway network elements, management element such as mobility management entities, operation and maintenance elements, and the like may be included.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication to or from an element, function or application, like a communication element, such as a UE, a communication network control element, such as an eNB, a gateway node like a PGW, a core network control element like a MME or another core network element, and other elements of the same or other communication networks besides those described in detail herein below.

A communication network may also be able to communicate with other networks, such as a public switched telephone network or the Internet. The communication network may also be able to support the usage of cloud services. It should be appreciated that network elements of an access system, of a core network etc., and/or respective functionalities may be implemented by using any node, host, server or access node etc. entity suitable for such a usage.

Furthermore, the described network elements, such as communication elements, like a UE, communication network control elements, access network elements etc., like an eNB, core network elements, like an PGW or MME etc., as well as corresponding functions as described herein, and other elements, functions or applications may be implemented by software, e.g. by a computer program product for a computer, and/or by hardware. For executing their respective functions, correspondingly used devices, nodes or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors.

It should be appreciated that according to some examples, a so-called “liquid” or flexible network concept may be employed where the operations and functionalities of a communication network element, network function, or of another entity of the communication network, such as of one or more of core network elements like a P-GW etc., may be performed in different entities or functions, such as in a node, host or server, in a flexible manner. In other words, a “division of labor” between involved network elements, functions or entities may vary case by case.

In order to improve the performance of communication networks, and in particular mobile communication systems, one approach is to increase the number of network nodes so as to enable a decrease of distance between user and network node so as to improve traffic capacity and extending the achievable user data rates of a wireless communication system. For achieving this, one solution is to deploy complementary low-power nodes e.g. under the coverage of an existing macro-node layer, also referred to as a heterogeneous network structure. By means of the low-power nodes, high traffic capacity and high user throughput can be provided locally, for example in indoor and outdoor hotspot positions.

In current and future network systems, such as LTE or LTE-A networks, enhancements related to low-power nodes and heterogeneous deployments are considered, for example, as so-called small-cell enhancement activities. In this context, interworking between the macro and low-power layers, including different forms of macro assistance to the low-power layer and dual connectivity are taken into account.

As indicated above, dual connectivity implies that a communication element such as a UE has simultaneous connections to both macro and low-power layers. A separation of control and data is possible, where, for example, the control signaling for mobility is provided via the macro layer at the same time as data connectivity is provided via the low-power layer.

In other words, dual connectivity is a mode of operation of a communication element like a UE being in a connected state (e.g. in RRC_CONNECTED state), wherein it consumes radio resources provided by at least two different network points which are referred to as master and secondary base stations or eNBs configured with a master cell group (MCG) and a secondary cell group (SCG). For example, the MeNB is, in dual connectivity operation mode, the eNB which terminates a link to the CN (e.g. the MME) and therefore acts as a mobility anchor towards the CN. The MCG is a group of serving cells associated with the MeNB. On the other hand, the SeNB is, in dual connectivity operation mode, an eNB providing additional radio resources for the UE, wherein the SeNB is not the MeNB. The SCG is a group of serving cells associated with the SeNB.

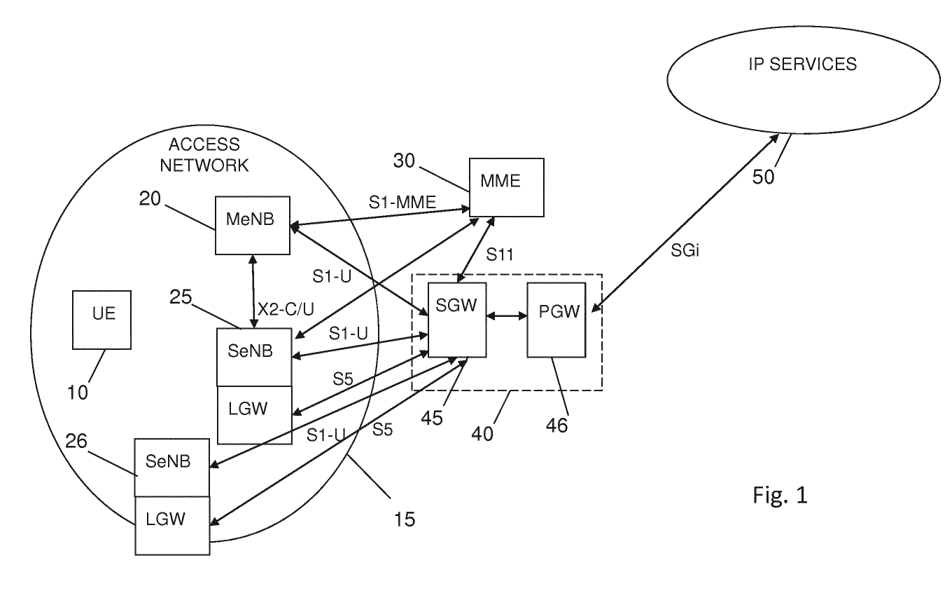

With regard to FIG. 1, a diagram illustrating a general architecture of a communication system is shown where some examples of embodiments are implementable. It is to be noted that the structure indicated in FIG. 1 shows only those devices, network elements and links which are useful for understanding principles underlying the examples of embodiments of the invention. As also known by those skilled in the art there may be several other network elements or devices involved in a communication in the communication system which are omitted here for the sake of simplicity.

In FIG. 1, a communication network is shown which forms a general basis of the example of a communication system according to some examples of embodiments. Specifically, as the network, a (wireless) communication network based for example on a 3GPP specification is provided. The communication network is configured to establish a communication connection to an external network, such as the Internet. It is to be noted that both the number of network elements as well as the type thereof, which are depicted in FIG. 1, are merely intended to provide a basis for illustrating the principles of a mobility control processing according to some examples of embodiments, while each one of the number and type of the involved network elements may be different to those shown in FIG. 1.

According to FIG. 1, reference sign 10 denotes a communication element, such as a UE, e.g. of a subscriber which represents one terminal point of a communication, i.e. for which one or more bearers, such as ERAB, are to be set up and used for communicating data to and from another terminal point of the communication. It is to be noted that according to examples of embodiments the UE 10 is assumed to be capable of conducting a dual connectivity operation mode.

Reference sign 15 denotes an access network via which the UE 10 is connected to the communication network. The access network comprises, for example, base stations, access nodes or the like. Specifically, as an illustrative but not limiting example, the access network 15 according to FIG. 1 comprises a macro base station which acts as a MeNB in case of a dual connectivity operation mode, a plural small base stations 25, 26 which may both act as a SeNB in case of a dual connectivity operation mode. According to the example indicated in FIG. 1, to the SeNBs 25, 26, a respective LGW is collocated allowing to access a defined network, such as an IP network like the Internet, directly from a local network such as a residential or enterprise IP network without requiring that the user plane traverse the mobile network (i.e. via a CN of a mobile communication network). MeNB 20 controls a corresponding MCG and SeNB 25 (or 26) controls a corresponding SCG.

Reference sign 30 denotes a management control element of the CN, such as a MME, which is configured to deal with a control plane and to handle signaling related to mobility and security for E-UTRAN access. For example, the MME is the termination point of the NAS.

Reference sign 40 denotes a control element of the CN, which comprises a gateway function acting as a serving gateway (SGW) 45 and a gateway to an external side, such as a PGW 46.

Reference sign 50 denotes IP services located in a network, such as the Internet, to which a connection can be established via the CN (e.g. PGW 46).

For connecting the elements and nodes indicated in FIG. 1, corresponding reference points or interfaces are defined. FIG. 1 shows examples of such interfaces and reference points under consideration of the LTE or LTE-A implementation, but it is obvious that in other implementations the used interfaces and reference points may be different.

Specifically, in the 3GPP LTE or LTE-A system depicted in FIG. 1, the MME 30 is connected to the eNBs 20, 25 and 26 via S1-MME. The SGW 45 is connected to the MME via S11, and to the eNBs 20, 25 and 26 via S1-U (for user plane). Furthermore, the SGW 45 is connected to LGW via S5. A connection between the MeNB 20 and the SeNBs 25, 26 is provided by X2-C/U (both user and control plane, only indicated for SeNB 25). Connection between the CN and the IP services is provided, for example, via PGW 46 and SGi.

It is to be noted that even though FIG. 1 shows only one UE 10 and a limited number of eNBs (both MeNB and especially SeNBs), it is obvious that also other configurations are feasible. For example, more than one UE can be connected to an eNB. Furthermore, as indicated above, it is assumed that the system and the communication element (UE 10) are configured to communicate in dual connectivity operation mode so that one or more bearers can be established between the UE 10 and at least two eNBs (e.g. MeNB 20 and SeNB 25).

The MeNB, at which e.g. the S1-MME terminates, performs all necessary S1-MME related functions (as specified for any serving eNB) such as mobility management, relaying of NAS signaling, ERAB handling, etc. and manages the handling of user plane connection.

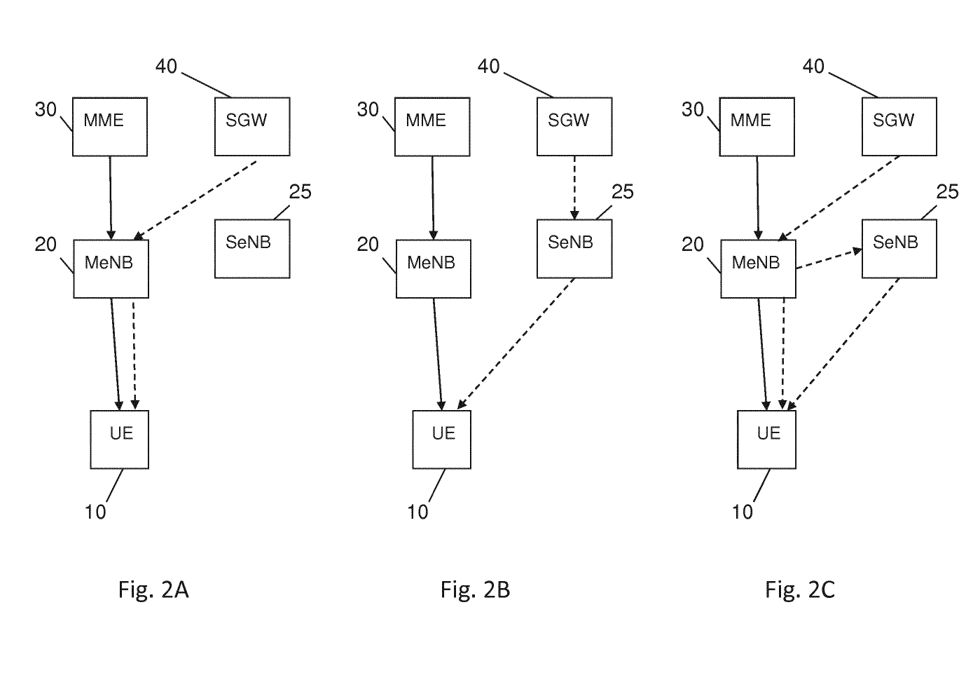

In dual connectivity operation mode, it is possible to split a bearer over multiple eNBs, which is also referred to bearer split. FIGS. 2a to 2c show examples of the three types of bearers that may be used in dual connectivity.

The examples in FIGS. 2a to 2c are based on the network depicted in FIG. 1 and comprise the MME 30, the SGW 40 (45), the MeNB 20, the SeNB 25 and the UE 10. According to examples of embodiments, the MeNB 20 is configured to carry control plane data to and from the UE 10 and to and from the SGW 40. Additionally the MeNB 20 is configured to carry control plane data to and from the SeNB 25. In this case, there is provided a S1-MME interface between the MeNB 20 and MME 30 and an X2-C interface between the

MeNB 20 and the SeNB 25.

FIG. 2a shows the case where there are MeNB bearers. In this case, control plane data (indicated by solid arrows) is transferred between the MeNB 20 and MME 30 as well as between the MeNB 20 and the UE 10. The user plane data (indicated by dashed arrows) may be provided between SGW 40 and the MeNB 20 and between the MeNB 20 and the UE 10. Thus the bearers carrying the user plane data are MeNB bearers.

FIG. 2b shows a case where the bearers are SeNB bearers. Similarly to FIG. 2a, control plane data is transferred between the MeNB 20 and the MME 30 as well as between the MeNB 20 and the UE 10. User plane data is provided between the SGW 40 and the SeNB 25 and the SeNB 25 and the UE 10. For SeNB bearers a user plane is directly connected between SGW and SeNB. The bearers for carrying user plane data to and from the UE 10 are SeNB bearers.

FIG. 2c shows a case where the bearers are split bearers. Similarly to FIGS. 2a and 2b, control plane data is transferred between the MeNB 20 and the MME 30 as well as between the MeNB 20 and the UE 10. User plane data is provided between the SGW 40 and the MeNB 20, the MeNB 20 and the SeNB 25, the MeNB 20 and the UE 10, and the SeNB 25 and the UE 10. That is, the bearers for carrying user plane data to and from the UE are split between the MeNB 20 and the SeNB 25.

That is, in dual connectivity, there are for example three types of bearer. For MCG (MeNB) bearers, the MeNB is U-plane connected to the SGW via S1-U, and the SeNB is not involved in the transport of user plane data. For split bearers, the MeNB is U-plane connected to the S-GW via S1-U and in addition, the MeNB and the SeNB are interconnected via X2-U. For SCG bearers, the SeNB is directly connected with the SGW via S1-U.

During mobility control, when the UE 10 is changing a location and comes into the area of the SeNB 25, for example, or due to connection quality reasons, the corresponding SeNB is added to the UE, for example. When adding a SeNB or SCG, such as SeNB 25, to UE 10 for communication in accordance with dual connectivity, the MeNB 20 may configure the SeNB 25 and the UE 10 for communicating with each other. In this case, the configuration between the SeNB 25 and the UE 10 may include bearers that are mapped to the SeNB 25 for carrying user plane data. For example, the MeNB 20 may offload bearers for a type of user data to the SeNB 25. For example, examples may comprise a video call or voice over LTE (VoLTE) calls, or any other user data bearers which can be mapped to the SeNB 25. The UE 10 executes, for example, a random access procedure towards the SeNB 25 for establishing a communication connection.

Basically, the SeNB 25 is added to the UE 10 once it has bearers mapped to it, for example the SeNB 25 is added only when a call such as a video call is initiated. During the addition of the SeNB 25, the UE 10 and the SeNB 25 are configured for dual connectivity including the configuration of the bearers. However, it is also possible that the SeNB 25 is added to the UE 10 without having any bearers mapped to it. That is, when SeNB 25 is added to the UE 10 without mapped bearers, the UE 10 and the SeNB 25 may change their behavior accordingly. For example, in some embodiments, the UE 10 may modify a time spent listening for transmissions from the SeNB 25. Furthermore, the communication between the UE 10 and the SeNB 25 may be limited to communication for keeping timing information of the UE 10 and the SeNB 25 synchronized, for example the communication may be limited to communication for adjusting a timing information. When a bearer is then subsequently mapped to the SeNB 25, the UE 10 and the SeNB 25 can communicate without the necessity to execute the random access procedure.

As indicated above, one mechanism to improve the performance of the communication network is to offload specific traffic to the small cells. For example, in case of internet traffic, this traffic can be offload to a local network from small cell eNBs by using SIPTO mechanism through a collocated LGW. Hence, packet traffic that previously traversed mobile CN can be routed directly to destinations without traversing the mobile CN.

When the UE 10, which is assumed to be capable of dual connectivity operation, is moving in MeNB 20 coverage towards SeNB 25 (with LGW capability), it is one goal to offload specific traffic, such as internet traffic, via the LGW of the SeNB 25 while other traffic is routed via operator network. In the following, examples of embodiments of the invention are described which explain, by using signaling procedures required for achieving such a functionality, an architecture, suitable control procedures and protocols allowing a mobility control for offloading traffic in a dual connectivity operation mode. As indicated above, a network structure as shown in FIG. 1 is used as an illustrative basic example.

For example, in a mobility control procedure, as a part of a transition from an idle state to a connected state, or when the UE sends a request for a PDP context, or when a PDN connectivity is requested request for an access point name which can be offloaded to a LGW (for example, offloading to LGW can be set in accordance with an APN and subscription profile), a management control element like the MME will setup the UE context in LGW by using a suitable interface, such as the S5 interface. As a part of this transaction, the LGW provides a correlation-ID which can be used by the eNB to send/receive the user plane packets to/from the LGW.

The MME knows the presence of the LGW at the SeNB on the basis of an indication, e.g. the LGW-IP-address, which is included, for example, in a S1 message which carries the NAS message triggering the PDN connection or PDP context which can be offloaded, as per configuration.

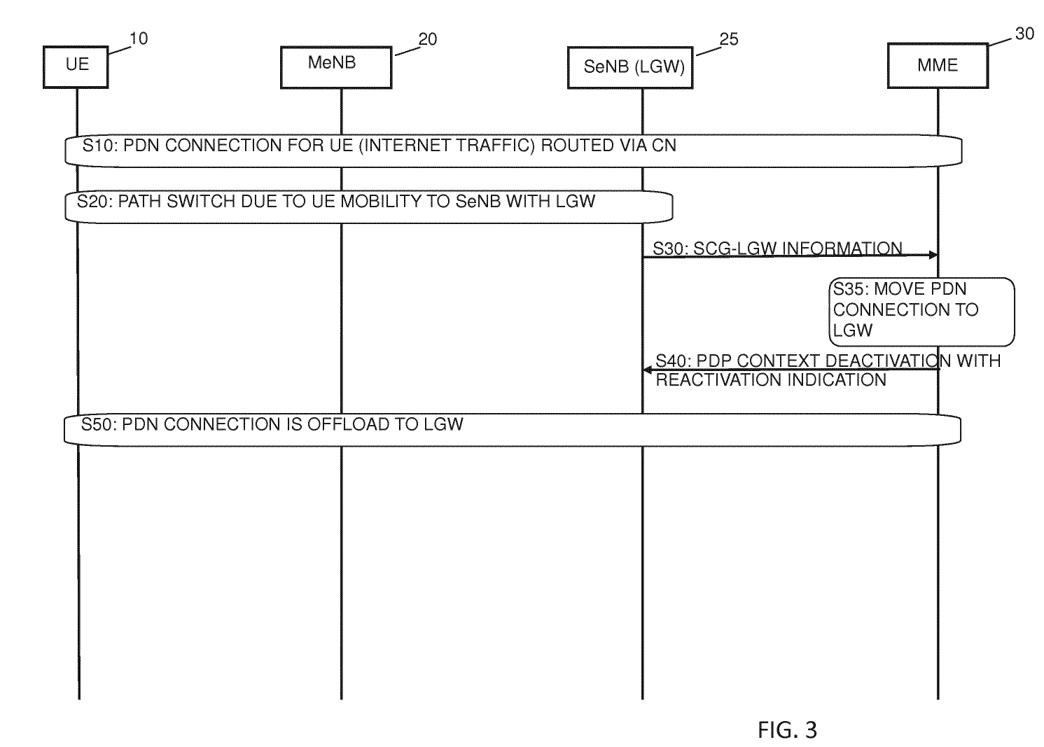

FIG. 3 shows a signaling diagram illustrating an example of a mobility control processing. Specifically, FIG. 3 illustrates a mobility control where offloading is involved in a single connectivity case.

In S10, the UE 10 starts a connection to an eNB without LGW (e.g. MeNB 20), wherein a PDN connection (e.g. Internet connection) is established via the mobile CN (because LGW is not supported by MeNB 20).

In S20, it is assumed that the UE 10 moves towards another eNB (such as SeNB 25), which has a LGW support in active mode. A path switch is conducted due to the mobility of the UE 10.

At the end of the path switch of S20, the target eNB (i.e. SeNB 25) informs in S30 the MME 30 about its LGW.

In S35, the MME 40 can decide to move (offload) the Internet PDN connection of the UE 10 to the LGW of SeNB 25. In this case, in S40, the MME 40 triggers a PDP context deactivation with reactivation indication and sends a corresponding message to the SeNB 25.

As part of the reactivation, in S50, the Internet PDN connection of UE 10 is offloaded to the LGW of the target SeNB, as described above.

It is to be noted that in case that in the scenario as depicted in FIG. 3 only one bearer (e.g. ERAB) is active on reception of path-switch at MME 30, the MME 30 triggers a UE detach procedure with cause to indicate reactivation. As a part of the detach procedure, the RRC connection to the UE 10 will be released. Consequently, the UE 10 sets up a RRC connection again to the SeNB 25 and sends a UE attach message. The SeNB 25 includes its LGW in the S1-Initial-UE message towards the MME 30. Then, the MME 30 sets up the PDP context with the LGW.

However, when applying the dual connectivity operation mode, when the UE 10 moves to SeNB 25 which also supports LGW, for example, the processing as described in connection with FIG. 3 is not applicable. For example, it is not possible to trigger the above mentioned offloading by the MME 30, since the MME 30 is not aware that the UE 10 is served by an eNB (e.g. SeNB 25) which supports LGW.

Thus, according to examples of embodiments, a mobility control mechanism is to be provided which is applicable for dual connectivity operation mode, so that the switching or movement of traffic, such as an Internet PDN connection, to a SCG with LGW (also referred to hereinafter as SCG-LGW) is possible. In this connection, according to some examples of embodiments, processing cycles concerning SCG addition→SCG release→SCG addition involved in switching of e.g. the Internet PDN connection to the SeNB supporting LGW are to be improved.

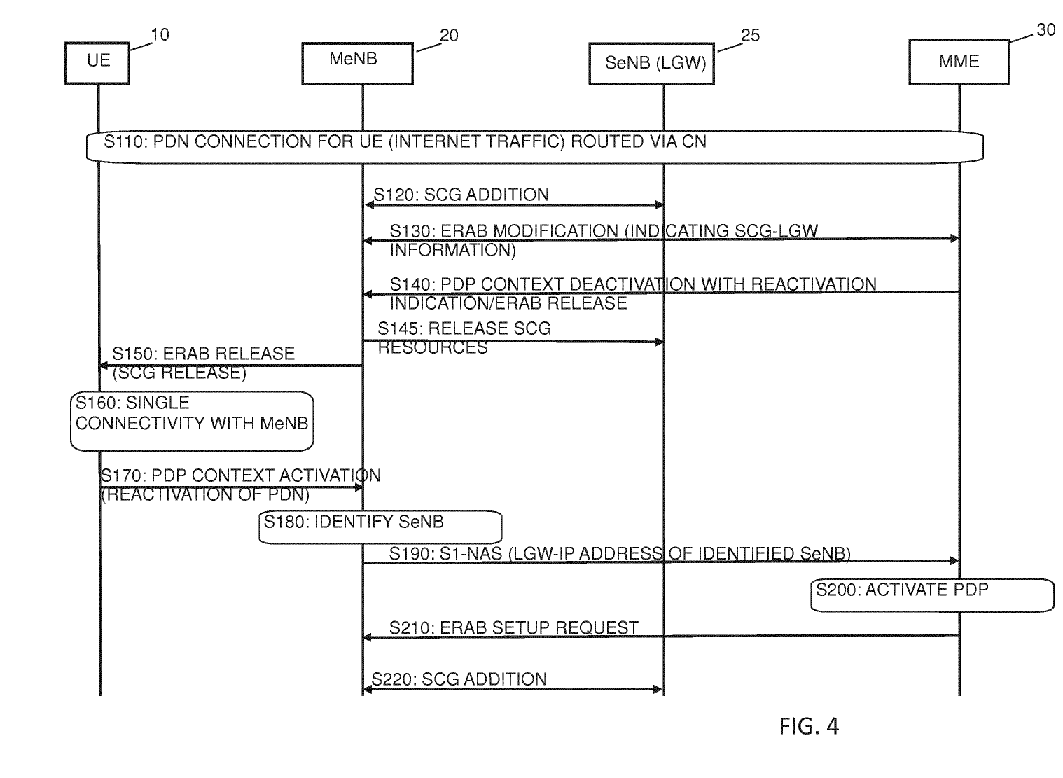

FIG. 4 shows a signaling diagram illustrating a mobility control processing according to some examples of embodiments. Specifically, FIG. 4 illustrates (on a high level) an approach for a mobility control in dual connectivity operation mode where the UE 10 moves to SeNB 25 (i.e. towards a small cell while being still in the coverage area of the MeNB 20, for example).

In S110, the UE 10 has a PDN connection to MeNB 20 (e.g. Internet connection) which is established via the mobile CN.

When the UE 10 reports e.g. suitable SCG-cell for dual connectivity (i.e. with LGW), such as cell of SeNB 25, the MeNB 20 triggers in S120 the SeNB addition procedure, for example for moving the Internet bearer from MeNB to SeNB (offloading). When the SCG is successfully added, the MeNB 20 informs the MME 30 in S130 about the bearer switching from MeNB 20 to SeNB 25 by using a bearer modification signaling, e.g. an ERAB-Modification message. In order to allow the MME 30 to decide on PDP context reactivation for switching the Internet bearer to SCG-LGW, the signaling to the MME in S130 includes SCG-LGW information.

The MME 30 decides to trigger PDP context deactivation with reactivation indication and to trigger an immediate release of this bearer (e.g. ERAB). A corresponding signaling is transmitted to the MeNB 20 in S140.

In response to the signaling in S140, the MeNB 20 triggers a SCG-release procedure, i.e. it sends a message to the SeNB in order to release the SCG resources in S145, and sends a bearer release signaling to the UE 10 in S150. Thus, in S160, the UE 10 moves back to single connectivity state with only MeNB 20.

In S170, the UE 10 sends a PDP context activation message for reactivation of the PDN connection to the MeNB 20.

However, alternatively, as indicated in FIG. 4, in S180, the MeNB 20 identifies the best candidates for a SCG, e.g. by using latest measurement reports. In S190, the MeNB 20 includes the LGW-IP address of the SeNB being the result of the measurement (which is e.g. the SeNB 25) in a signaling to the MME (e.g. S1 message which carries the NAS message).

Based on this LGW-IP address, the MME 30 activates in S200 the PDP context towards the given SeNB-LGW.

In S210, the MME 30 sends a bearer setup request (e.g. ERAB setup request) to the MeNB 20. It is to be noted that before sending the ERAB setup to the MeNB 20, the MME 30 may also set up a connection with the SCG-LGW (i.e. SeNB 35, for example), set up the bearer context and obtain the correlation-ID.

Further in FIG. 4, the MeNB 20 triggers in S220 a SCG addition procedure with SeNB 25 wherein the received ERAB parameters including correlation-ID are passed to the SeNB 25.

In the processing described in connection with FIG. 4, as part of the UE mobility towards SeNB and switching of the internet PDN connection to SeNB-LGW, the SCG addition, SCG release and SCG addition procedures are executed immediately one after another. That is, the number of signaling procedures is not optimal since there may be redundant signaling procedures, which may cause also a delay in the offloading of the Internet PDN towards SeNB.

Consequently, according to some further examples of embodiments, processing at the MME and the MeNB is further modified. For example, according to some examples of embodiments, a correct target SeNB is selected for offloading during reactivation wherein the SCG is kept active without bearers.

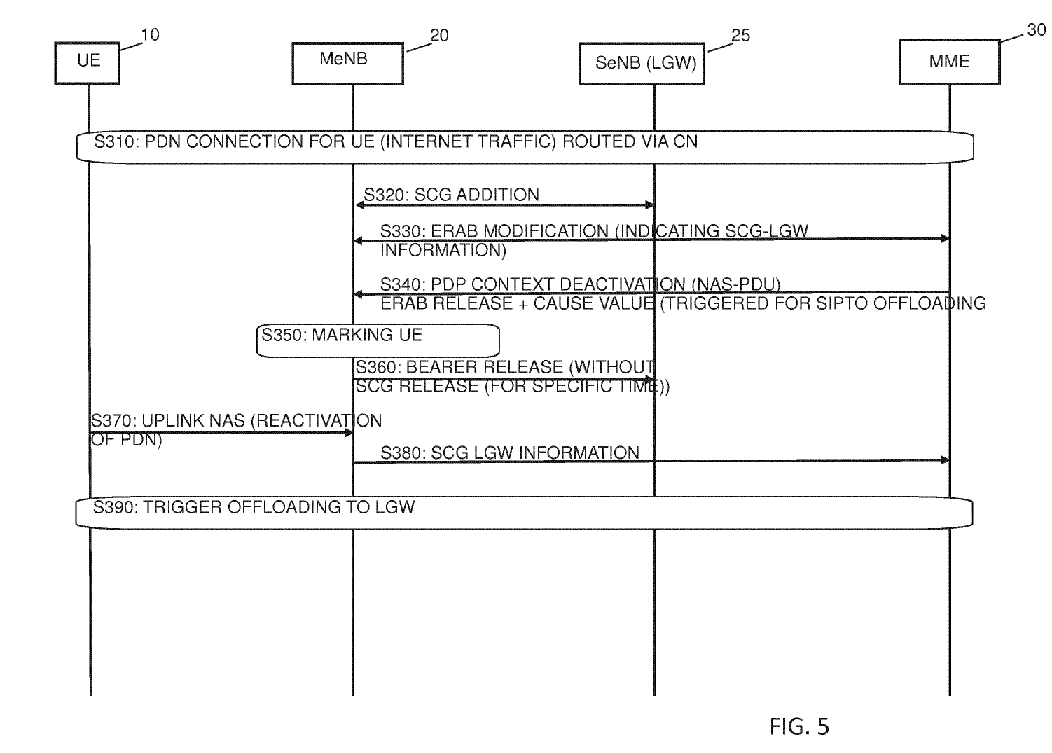

FIG. 5 shows a signaling diagram illustrating a mobility control processing according to some examples of embodiments. Specifically, the processing in FIG. 5 is related to handle the setup of a bearer eligible, i.e. designated, or appointed, or applicable, or suitable for selected traffic offload (which is also referred to hereinafter as a SIPTO bearer) in a SCG and also to offload the SIPTO bearer to SCG and SCG-LGW on SCG addition.

According to some examples of embodiments, for setting up a SIPTO bearer at the SCG and the SCG-LGW (i.e. setting up ERAB directly in the SeNB along with SCG-LGW), the MeNB 20 can provide the SCG-LGW IP address in a signaling to the MME, e.g. in the S1 initial UE message. The MeNB 20 is able to identify the bearer to be set up in the SCG on the basis of the correlation ID associated with the bearer (e.g. ERAB).

On the other hand, in case of a mobility scenario as indicated in FIG. 5, for example, after the successful SCG addition with movement of some bearers to SCG as SCG bearers, the MeNB 20 may include an additional parameter related to SCG-LGW in a S1-ERAB-Modification message to the MME 30. Based on this information, the MME 30 triggers the offloading by using PDP context deactivation for the internet PDP context with cause indicating the reactivation. This will be described in detail on the basis of the signaling diagram in FIG. 5 which is related to a mobility scenario where a CN bearer is moved to the SCG-LGW.

In S310, the UE 10 has a PDN connection to MeNB 20 (e.g. Internet connection) which is established via the mobile CN.

When the UE 10 reports e.g. suitable SCG-cell for dual connectivity (i.e. with LGW), such as a cell of SeNB 25, the MeNB 20 triggers in S320 the SeNB addition procedure.

When the SCG addition is successful, the MeNB 20 informs the MME 30 in S330 about the SCG-LGW by a corresponding signaling, such as S1 ERAB modification request message.

The MME 30 triggers a bearer release by sending a corresponding signaling to the MeNB 20 in S340, the signaling comprising e.g. an ERAB release containing NAS PDU for PDP context deactivation. The MME 30 indicates an additional cause value in the signaling of S340 for indicating that the ERAB release is triggered for SIPTO offloading in the ERAB release request message.

Based on this information, in S350, the MeNB 20 marks UE 10 for SCG addition on reception of next uplink NAS message. When a next uplink NAS message is received, as per the latest measurement, if there is a SCG suitable for addition with valid SCG-LGW, this SCG-LGW information will be sent to the MME 30 for enabling offloading of the Internet PDN to SCG/SCG-LGW.

Furthermore, when receiving the ERAB release with the additional cause value in S340, the MeNB 20 triggers in S360 only a SCG bearer release without releasing the SCG. That is, the SCG is kept alive without bearer for some specific duration. Hence, whenever the next NAS-PDU containing reactivation is received, the MeNB 20 sends the SCG-LGW information to the MME so that offloading is triggered to the SCG which is active already.

That is, when in S370 the UE 10 sends an uplink NAS message over an existing RRC connection for reactivation of the PDP context to the MeNB 20, the MeNB 20 sends the SCG-LGW information to the MME 30 in S380, and offloading is triggered to the SCG in S390.

With the approach described in connection with FIG. 5, it is possible that the SCG mobility between the time between a release of the bearer and the reactivation is tracked via SCG change as there is SCG which is active. Thus, SIPTO offloading can be achieved in dual connectivity operation mode. However, there are involved several signaling procedures, such as two X2 signaling messages, one RRC signaling procedure and one S1 signaling procedure for path-switch.

According to further examples of embodiments, a mobility control procedure is defined in which such additional signaling procedures are further optimized.

Specifically, according to some examples of embodiments, the required amount of signaling is further optimized wherein also less data interruption is achieved. That is, a mechanism is provided fast SIPTO offloading wherein information related to SIPTO offloading per bearer being known to the MME is used.

That is, according to some examples of embodiments, the MME informs the MeNB, for example as part of the bearer setup itself, about additional related to the bearer in case it is a so-called “SIPTO bearer”, for example. That is, the MME includes a corresponding information or indication when the UE requests for setup of an Internet-PDN or the like, when it is determined, e.g. as per subscription and policy, that this bearer will be offloaded in case a LGW is found or available.

It is to be noted that in case the UE sets up an Internet PDN connection from the MeNB (which does not support LGW), this information is to be understood in such a manner that the bearer (e.g. ERAB) corresponds to a SIPTO bearer. Consequently, the MME will trigger offloading whenever it detects a movement of the UE towards a network part or node which supports LGW.

According to examples of embodiments, the MeNB stores this information e.g. in a UE context. When a SCG addition towards a SeNB with LGW occurs, the following processing is possible.

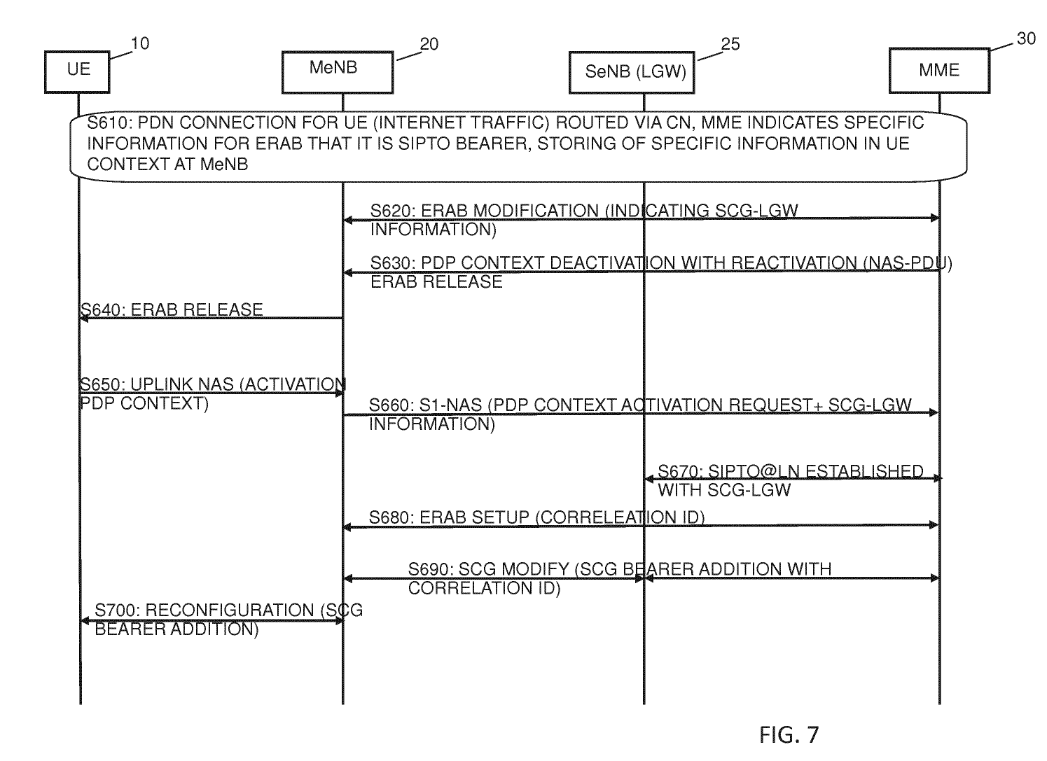

In case a SIPTO bearer is present for a UE in question (i.e. a UE being subject of mobility control), this bearer will not be moved to the SeNB. Instead, a signaling, such as 51 ERAB modification message, is sent after a SCG addition, which includes the SCG-LGW of the SeNB (this will be further discussed in connection with FIG. 7, for example)

In case there are present a SIPTO bearer and a MCG bearer at the moment of the SCG addition, the MeNB executes a processing for setting up the SCG without bearer (as discussed above) and avoids the movement/switching of the SIPTO bearer to SCG at this moment. The MeNB sends a signaling, such as an ERAB modification message, to the MME and indicates the SCG-LGW of the SeNB. It is to be noted that this message does not change any downlink endpoints of the ERABs so that no failure indication is to be expected from the MME.

It is to be noted that for reducing the signaling load the MeNB sends, according to some examples of embodiments, a single RRC reconfiguration message to the UE which comprises information related to the release of the bearer (ERAB) and to the addition of the SCG.

In case, for example, that only a SIPTO PDN connection is present at the moment of decision on a SCG addition (for example, it is determined that there is only one bearer available for the UE 10), according to some examples of embodiments, the MeNB sends a S1 ERAB modification message with the SCG-LGW information to the MME. The MME triggers a UE detach to move the bearer, since this is the only bearer at this moment. At the end of the UE detach, when the MME releases the S1 UE context, it provides information related to S-TMSI to the MeNB. The MeNB marks this S-TMSI to trigger bearer movement to SCG with SCG-LGW on next RRC connection setup. On reception of the first S1 message over the new RRC connection for the same S-TMSI, the MeNB checks on the basis of the latest measurement results a suitable SCG with associated LGW and sends this info in the S1 message to the MME. Further offloading of the bearer to SCG and SCG-LGW continues based on correlation ID of the bearer at the MeNB, as described above.

In other words, according to some examples of embodiments, a mobility control procedure is provided allowing a fast offloading of specific traffic, e.g. a SIPTO offloading, on the basis of information being provided beforehand by the management control element like the MME and being related to bearer (e.g. ERAB) handling and on the basis of a usage of the information at the communication network control element, like the MeNB, for example, for executing movement of the bearer to a LGW of a target cell group, e.g. a cell group controlled by the SeNB.

For example, according to some examples of embodiments of the invention, the mobility control processing comprises that the MME informs the MeNB, in case a PDN connection is activated or established for which offloading e.g. to LGW is enabled, whether an immediate offloading is triggered as soon as it detects movement of the UE to a SeNB with LGW, for example. For example, the MME includes a corresponding indication, such as an offload-on-LGW-change parameter, as part of a S1 signaling between the MME and the MeNB. Thus, the MeNB is able to learn, at a bearer level, whether it is linked to an APN whose traffic will be offloaded to LGW when the UE moves to SeNB which supports LGW. According to some examples of embodiments, this information is stored against each bearer (e.g. ERAB) and is used by the MeNB to trigger a specific way of SeNB addition.

For example, according to some examples of embodiments, on the basis of the information, whenever the MeNB detects in a mobility control procedure a movement of the UE to a SeNB with LGW, the MeNB sets up the SCG without any bearer movement. Then, the MeNB indicates the SCG-LGW information via a bearer medication signaling, e.g. via a S1 ERAB modification message to tunnel the information. The MME now triggers the bearer release, e.g. by means of an ERAB release message containing a PDP context deactivation instruction with a cause value (e.g. in the ERAB release message) indicating a PDP context reactivation.

According to some examples of embodiments, the MeNB can inform the UE by including information about the bearer release (ERAB release) and SCG addition (including information that addition is done without SCG Bearer) by sending a single message (e.g. RRC message) towards the UE.

In the following, according to some examples of embodiments, when receiving a UE uplink NAS message, the MeNB includes the SeNB-LGW IP address for enabling the MME to set up a UE context with regard to the SeNB-LGW IP address. Then, Internet PDP context in SCG can be set up and the offloading via SeNB-LGW can be conducted.

By means of such a mobility control as discussed above, when the MeNB knows in advance the MME behavior for SIPTO offload triggering, the MeNB can avoid a movement of the Internet PDP context to the SeNB as part of the MeNB-to-SeNB mobility. Instead, the SCG is set up without bearers. The reactivation of PDP context is possible directly at SeNB-LGW along with switching of Internet PDP context to SeNB in a compact manner.

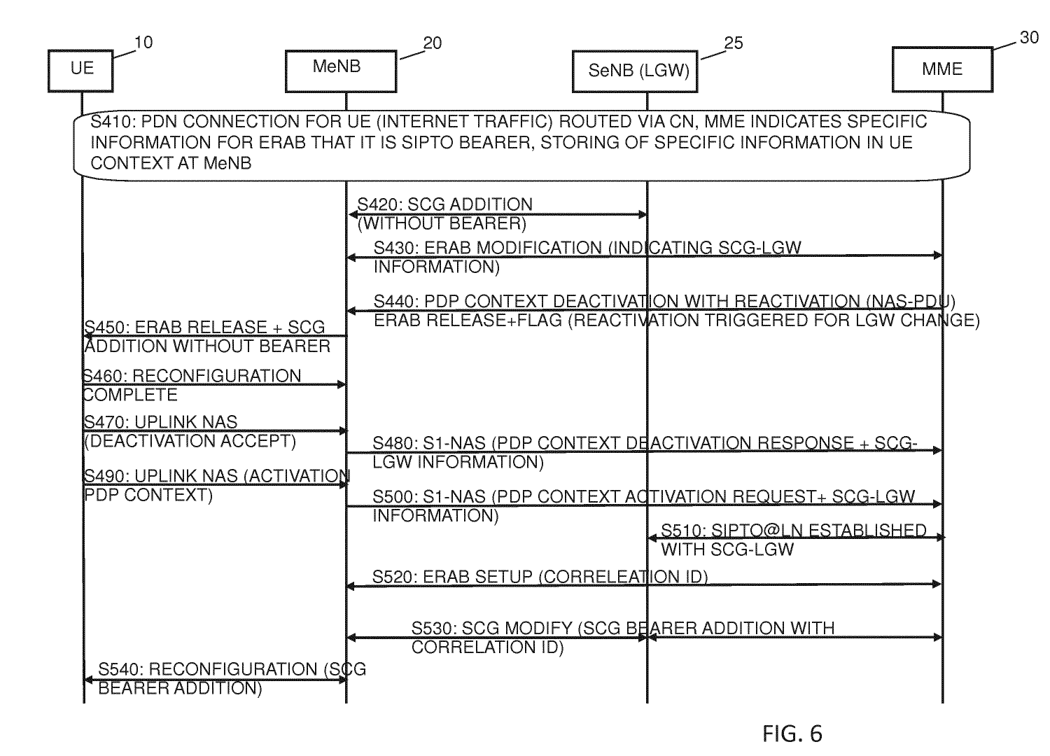

FIG. 6 shows a signaling diagram illustrating a mobility control processing according to some examples of embodiments. Specifically, the processing in FIG. 6 is related to a sequence of a mobility control procedure considering above indicated aspects related to a MeNB-to-SeNB mobility scenario with dual connectivity operation mode including a fast SIPTO offloading.

In S410, the UE 10 has a PDN connection to MeNB 20 (e.g. Internet connection) which is established via the mobile CN. That is, the UE 10 establishes e.g. a PDP context corresponding to an Internet PDN for which SIPTO@LN is enabled (for example according to operator policy and/or subscription). According to examples of embodiments, at the time of bearer establishment (e.g. establishment of ERAB) for this PDP context, the SIPTO was not activated because the MeNB 20 does not support LGW. The MME 30 provides additional information for this bearer (ERAB) which indicates that this bearer is a “SIPTO bearer” (i.e. dedicated for selected traffic offloading). The information is stored by the MeNB, for example, in the UE context against this bearer. Thus, when a SeNB with LGW is added to the UE at any later point in time, the information is usable, for example, for avoiding movement of the bearer to SCG; instead it is waited for a reactivation to happen.

When the UE 10 reports e.g. suitable SCG-cell for dual connectivity (i.e. with LGW), such as a cell of SeNB 25, the MeNB 20 triggers in S420 the SeNB addition procedure. That is, when the UE 10 moves towards the SeNB 25 and the MeNB 20 identifies that the target cell (i.e. SeNB 25) supports LGW for SIPTO offloading, it is checked whether the UE context indicates that the bearer in question is a SIPTO bearer (according to the information stored in S410). If this is the case, the MeNB triggers a SeNB addition procedure without any bearers associated with it in S420. The SCG addition without bearer allows to avoid an immediate release of SCG based on MME initiated PDP deactivation, for example.

In S430, in reaction to a successful SeNB addition, the MeNB conducts a signaling with the MME 30, e.g. by sending a bearer modification message like a S1 ERAB modification message, in order to inform the SeNB-LGW to MME 30. It is to be noted that there is no change in the tunnel endpoints at this instance. Furthermore, the MeNB 20 does not initiate a RRC message to the UE 10 at this point of time regarding the SCG addition; instead, it is waited for a bearer release instruction from the MME 30 before initiating an information towards the UE 10.

In S440, the MME 30 triggers a bearer release, e.g. by sending an ERAB release message with a NAS-PDU containing a PDP context deactivation instruction with reactivation indication to MeNB. According to some examples of embodiments, the message in S440 includes also an indication such as a flag for indicating that the reactivation is triggered for a LGW change. For example, according to some examples of embodiments, this flag is used by the MeNB 20 to decide whether to keep the SCG without bearer for some more time (i.e. a configured duration) or not.

In S450, the MeNB 30 generates a message to the UE 10, such as a RRC message, which includes information related to the SCG addition and the release of the bearer (ERAB).

The UE 10, when receiving the message in S450, releases the bearer, establishes SCG connectivity and completes the random access procedure towards the SeNB 25. This is indicated to the MeNB 20 in a reconfiguration complete message in S460.

In S470, the UE 10 sends an uplink NAS message to accept the deactivation to the MeNB 20. The MeNB 20 sends this acceptance indication with SCG-LGW information to the MME 30 in S480, e.g. as a S1 NAS message comprising a PDP context deactivation response. The SCG-LGW information can be included since the UE context information includes the SCG information in it.

In S490, the UE 10 sends a further uplink NAS message for activation of the PDP context to the MeNB 20. The MeNB 20 sends this message, e.g. as a S1 NAS message, along with SCG-LGW IP address to the MME 30, in S500.

When receiving the message of S500, the MME 30 triggers in S510 a setup procedure, such as a S5 procedure, towards the SCG-LGW to set up the LGW UE context. In this context, the MME 30 receives the correlation ID from the LGW.

Then, in S520, the MME 30 triggers a bearer setup (e.g. ERAB setup) towards the SeNB and provides the correlation ID to the MeNB 20.

In S530, the MeNB 20 sets up this bearer on the SeNB 25 (bearer addition procedure) wherein the available information including the correlation ID is provided to the SeNB 25.

In S540, the UE 10 is informed by the MeNB 20 about the addition of the bearer (ERAB) via a suitable signaling, e.g. via a RRC connection reconfiguration message.

Thus, the SeNB 25 can start its SCG bearer offloading directly to its LGW by using the correlation ID as identification of e.g. the user plane packets.

In the following, according to some further examples of embodiments, an alternative mobility control procedure is illustrated where the SCG addition without bearer (see e.g. S420 of FIG. 6) is not conducted. Specifically, FIG. 7 shows a signaling diagram illustrating a corresponding mobility control processing according to some examples of embodiments. Specifically, the processing in FIG. 7 is related for example to a case where e.g. a SIPTO bearer is present for the UE, wherein this bearer will not be moved to the SeNB but a signaling is sent after SCG addition, which includes the SCG-LGW of the SeNB. That is, when the MeNB knows that the target SeNB has LGW connectivity and there is a bearer (e.g. ERAB) marked as SIPTO bearer, instead of setting up SCG without bearer, a modification message is directly sent in order to indicate the need for PDP reactivation, e.g. by sending the SCG-LGW IP address to MME.

For example, as indicated in FIG. 7, starting at S610, the UE 10 has a PDN connection to MeNB 20 (e.g. Internet connection) which is established via the mobile CN. That is, the UE 10 establishes e.g. a PDP context corresponding to an Internet PDN for which SIPTO@LN is enabled (for example according to operator policy and/or subscription). The MME 30 provides additional information for this bearer (ERAB) which indicates that this bearer is a “SIPTO bearer” (i.e. dedicated for selected traffic offloading). The information is stored by the MeNB, for example, in the UE context against this bearer. Thus, when a SeNB with LGW is added to the UE at any later point in time, the information is usable, for example, for avoiding movement of the bearer to SCG.

When the UE 10 reports e.g. suitable SCG-cell for dual connectivity (i.e. with LGW), such as a cell of SeNB 25, i.e. when the UE 10 moves towards the SeNB 25 and the MeNB 20 identifies that the target cell (i.e. SeNB 25) supports LGW for SIPTO offloading, it is checked whether the UE context indicates that the bearer in question is a SIPTO bearer (according to the information stored in S410). According to the example of FIG. 7, if this is the case, the MeNB 20 sends in S620 directly a bearer modification message, such as a S1 ERAB modification message to the MME 30 in order to indicate the need for PDP reactivation. The message comprises the SCG-LGW IP address.

In S630, the MME 30 triggers bearer release (e.g. ERAB release). The MeNB 20 sends this ERAB release to the UE 10 via a RRC connection reconfiguration message in S640. In this connection, the MeNB 20 saves the SCG associated to the last connection.

In S650, the MeNB 20 receives from the UE 10 an uplink NAS message for activating a PDP context, for example. In S660, the MeNB 20 sends this message to the MME 30 in a S1 NAS message along with the SCG-LGW being stored in an earlier phase.

Further processing including S670, S680, S690 and S700 lead to a processing where the MME 30 establishes e.g. the S5 connection with the SeNB-LGW and the MeNB 20 triggers the SeNB addition to the SeNB 25 along with correlation ID information, as described in connection with FIG. 6 in S510 to S540.

With the processing described in connection with FIG. 7, it is possible to simplify the mobility control procedure for enabling SCG bearer offloading directly to its LGW by using the correlation ID as identification of e.g. the user plane packets. However, the MeNB 20 may not have an associated SeNB when it receives the uplink NAS message containing PDP context activation which will trigger LGW offloading. Thus, the MeNB 20 may depend, for selecting a suitable SeNB, on inter-frequency measurement results.

It is to be noted that according to some further examples of embodiments, it is also possible to improve a mobility control procedure in case of a mobility scenario between two SeNBs with LGW, i.e. a SeNB-to-SeNB mobility.

For example, when an MeNB (e.g. MeNB 20 in FIG. 1) receives a UE measurement report indicating mobility towards a new SeNB (e.g. from SeNB 25 to SeNB 26) which have also an own LGW, according to some examples of embodiments, the MeNB 20 may be configured to execute the following control procedure.

First, the MeNB 20 triggers a SeNB addition procedure with the target-cell (i.e. of SeNB 26, for example) without SIPTO bearer.

When receiving a response from the target SeNB 26, the MeNB 20 sends a message to the source SeNB 25 to release the SIPTO bearer.

Then, the MeNB 20 waits for a MME message to release the bearer before sending the a message (e.g. RRC message) to the UE 10. It is to be noted that the MeNB 20 knows that the SeNB 26 has triggered the PDP context reactivation, e.g. based on a SeNB release acknowledgement message.

When the MeNB receives the bearer release message from the Mme, it sends a message (e.g. a single RRC message) to the UE 10 indicating the release of the bearer (e.g. ERAB) along with information indicating SCG switching.

Then, the UE 10 can send a NAS message to reactivate the PDP context. The MeNB sends this NAS message in a S1 message to the MME, wherein the message also includes the target SCG-LGW IP address. Thus, the MME 30 can trigger the SIPTO bearer offloading to SeNB-LGW in a manner as described in connection with FIG. 6, for example.

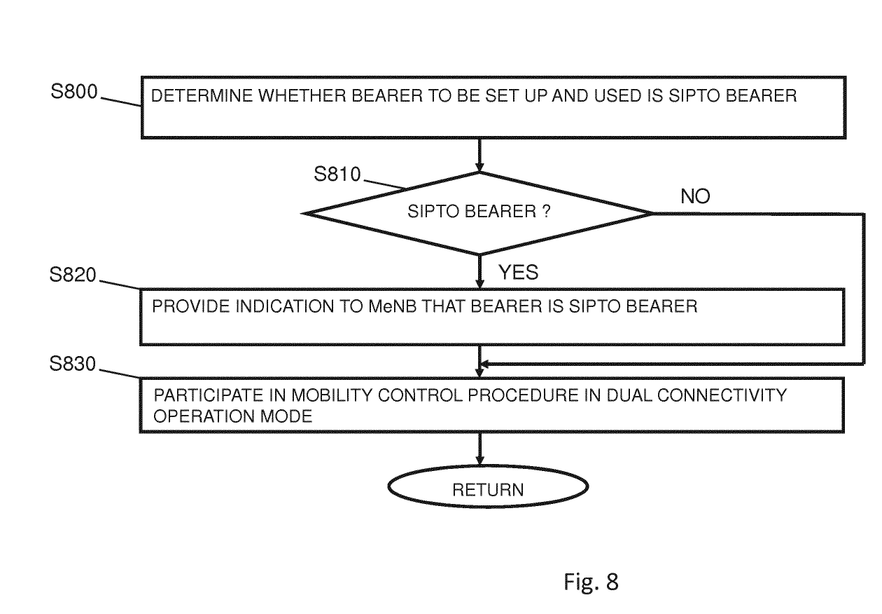

FIG. 8 shows a flow chart of a processing conducted in a management control element, such as the MME 30, according to some examples of embodiments. Specifically, the example according to FIG. 8 is related to a control procedure conducted by the management control element, function or node acting as an MME in the communication network as depicted e.g. in FIG. 1.

In S800 and S810, it is determined whether a bearer to be set up and used for a communication connection of a communication element like UE 10 is a bearer eligible (i.e. designated, or appointed, or applicable, or suitable) for selected traffic offloading (i.e. SIPTO according to some examples of embodiments) to a local gateway like LGW of SeNB 25) of a cell group (e.g. SCG) when the LGW is available (i.e. the SCG comprises a LGW).

According to some examples of embodiments, for determining whether the bearer is a SIPTO bearer for offloading to the local gateway, subscriber information and policy information related to the UE requesting a bearer setup are considered.

In case the determination in S810 is affirmative, i.e. the bearer in question is determined to be a SIPTO bearer, in S820, an indication is provided in a signaling to a communication network control element (e.g. the MeNB 20) of the UE. This indication indicates that the bearer in question (i.e. the bearer to be set up) is a SIPTO bearer and that traffic offloading to a LGW is conducted as soon as a LGW is available.

According to some examples of embodiments, the indication is provided in a bearer release signaling e.g. as a cause value informing that the bearer release is triggered for SIPTO, for example.

Alternatively, according to some examples of embodiments, the indication is provided in a bearer setup signaling.

Then, in S830, a processing for participating in a mobility control procedure in dual connectivity operation mode is executed. It is to be noted that in case the determination in S810 is negative, i.e. the bearer in question is not determined to be a SIPTO bearer, the process proceeds also to S830, wherein in this case no indication regarding a SIPTO bearer is provided to the MeNB.

According to some examples of embodiments, the participation in the mobility control procedure in dual connectivity operation mode comprises receiving and processing a bearer modification message including information about the target cell group and the local gateway included in the target cell group. When it is determined that there is only one bearer available for the UE, a UE detach procedure is triggered for moving the bearer. Then, information related to a temporary mobile subscriber identity (e.g. S-TMSI) is transmitted to the MeNB, e.g. by means of S1 release signaling.

According to some further examples of embodiments, the participation in the mobility control procedure in dual connectivity operation mode comprises to trigger, by initiating a PDP context reactivation, an immediate offloading of the SIPTO bearer when it is detected that a LGW is available in a target cell group (e.g. SCG) to which at least a part of a communication conducted by the UE is switchable (i.e. to which the UE has been moved, for example).

Furthermore, according to some examples of embodiments, a bearer modification message including information about the target cell group and the LGW included in the target cell group (e.g. SCG) is received and processed, and a bearer release is triggered by providing a signaling including a PDP context deactivation instruction comprising a PDP context reactivation indication towards the network (i.e. the MeNB). In this signaling, an information such as a flag is included which indicates that the context reactivation is triggered for moving the bearer to the LGW.

Moreover, according to some examples of embodiments, a signaling related to an activation of a PDP context for a SIPTO bearer eligible for offloading to a LGW is received and processed. The signaling includes address information of the target cell group (e.g. SCG). Then, a connection to a communication network control element (e.g. SeNB) associated to the target cell group (e.g. SCG) is established for setting up a context with the LGW of the target cell group. In reaction thereto, a correlation identification element of the LGW is received and processed. According to some examples of embodiments, a bearer setup to the target cell group is initiated by using the correlation identification element.

In addition, according to some examples of embodiments, the target cell group comprises a SCG, while a source cell group from which at least a part of a communication conducted by the UE is to be switched comprises one of a MCG and a SCG.

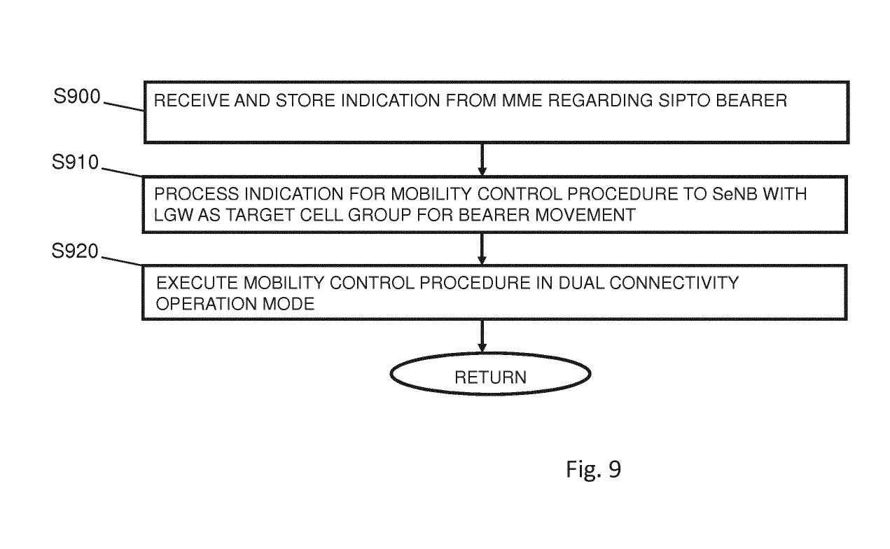

FIG. 9 shows a flow chart of a processing conducted in a communication network control element, such as the MeNB 20, according to some examples of embodiments. Specifically, the example according to FIG. 9 is related to a control procedure conducted by the communication network control element, function or node acting as an MeNB in the communication network as depicted e.g. in FIG. 1.

In S900, in case a bearer is to be set up and used for a communication connection of a communication element, such as the UE 10 of FIG. 1, an indication is received in a signaling from a management control element such as the MME 30. The indication indicates that the bearer to be set up is a bearer eligible for selected traffic offloading, i.e. a SIPTO bearer, as soon as a LGW is available.

According to some examples of embodiments, the indication is received in a bearer release signaling e.g. as a cause value informing that the bearer release is triggered for SIPTO, for example.

Alternatively, according to some examples of embodiments, the indication is received in a bearer setup signaling.

In S910, the indication is processed in a control procedure for controlling a movement of at least one bearer of the UE from a source cell group to a target cell group.

For example, according to some examples of embodiments, the target cell group comprises a SCG, while the source cell group comprises one of a MCG and a SCG.

According to some examples of embodiments, in the processing of the indication in the control procedure for controlling the movement of at least one bearer of the UE from the source cell group to the target cell group, it is detected that the UE to which the bearer belongs is communicating with a target cell group supporting a LGW being usable for selected traffic offloading. Furthermore, it is determined that a bearer to be set up for the target cell group corresponds to the SIPTO bearer being indicated in the stored indication.

In S920, a processing for executing a mobility control procedure in dual connectivity operation mode is conducted.

According to some examples of embodiments, the processing comprises to execute an addition procedure for adding the target cell group without bearer setup towards the target cell group. Then, a bearer modification message comprising information about the target cell group and the LGW supported thereby is transmitted to the management control element (i.e. the MME).

Furthermore, according to some examples of embodiments, a bearer release signaling is received and processed which includes a PDP context deactivation instruction comprising a PDP context reactivation indication. In the signaling, an information is included which indicates that the context reactivation is triggered for moving the bearer to the LGW. Then, a message is transmitted to the UE including information regarding the addition of the target cell group and the release of the bearer.

According to some examples of embodiments, it is determined whether the target cell group without bearer setup is to be kept for a configured duration on the basis of the information included in the signaling.

Moreover, as an alternative to a SCG addition without bearer, according to some examples of embodiments, a bearer modification message is transmitted to the MME which indicates a need for a PDP context reactivation, wherein the message comprises information about an address of the LGW supported by the target cell group. According to some examples of embodiments, in this case, the processing in S920 comprises also to receive and process a bearer release signaling including a PDP context deactivation instruction comprising a context reactivation indication, wherein an information such as a flag is included in the signaling, which indicates that the context reactivation is triggered for moving the bearer to the LGW. Then, a message is transmitted to the UE including information regarding the release of the bearer, wherein a connection to the target cell group (e.g. SCG) associated with a previous connection is kept. According to some examples of embodiments, the target cell group is selected on the basis of an inter-frequency measurement result.

Moreover, the processing in S920 comprises, according to some further examples of embodiments, that in case both the target cell group and the source cell group are SCGs with LGW, the SIPTO at the source cell group is released when the target cell group is added.

Furthermore, according to some examples of embodiments, a signaling related to an activation of a PDP context for a SIPTO bearer eligible for offloading to a LGW is transmitted to the MME, wherein the signaling includes address information of the target cell group.

Moreover, according to some examples of embodiments, a bearer setup signaling for initiation of a setup of a bearer to the target cell group is received and processed, wherein the signaling includes a correlation identification element of the LGW. A bearer setup procedure to the target cell group is conducted, wherein information including the correlation identification element are provided to the target cell group. In addition, the UE is informed about the addition of the bearer to the LGW.

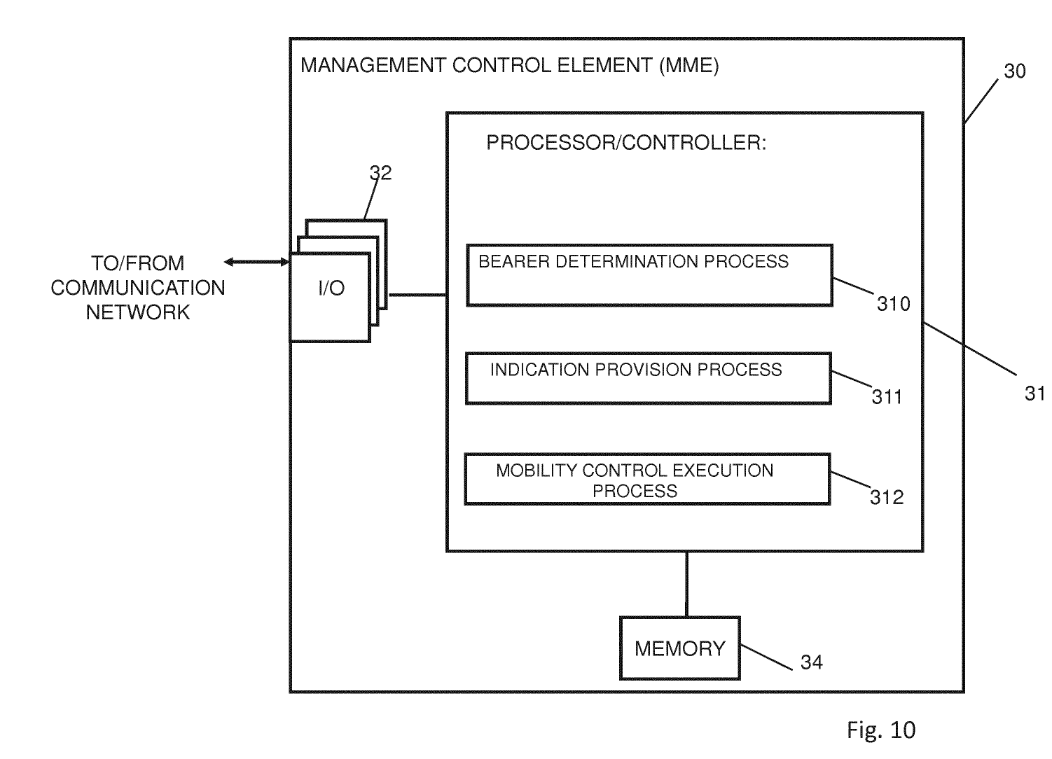

FIG. 10 shows a diagram of a management control element according to some examples of embodiments, which is configured to implement a control procedure as described in connection with some of the examples of embodiments. It is to be noted that the management control element, like the MME 30, which is shown in FIG. 10, may include further elements or functions besides those described herein below. Furthermore, even though reference is made to a management control element or node, the element or node may be also another device or function having a similar task, such as a chipset, a chip, a module, an application etc., which can also be part of a management control element or attached as a separate element to a management control element, or the like. It should be understood that each block and any combination thereof may be implemented by various means or their combinations, such as hardware, software, firmware, one or more processors and/or circuitry.

The management control element shown in FIG. 10 may include a processing circuitry, a processing function, a control unit or a processor 31, such as a CPU or the like, which is suitable for executing instructions given by programs or the like related to the control procedure. The processor 31 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference sign 32 denotes transceiver or input/output (I/O) units or functions (interfaces) connected to the processor or processing function 31. The I/O units 32 may be used for communicating with other network elements, such as the MeNB 20, the SeNB(s) 25, 26, the LGWs, and the like. The I/O units 42 may be a combined unit including communication equipment towards several network elements, or may include a distributed structure with a plurality of different interfaces for different network elements. Reference sign 34 denotes a memory usable, for example, for storing data and programs to be executed by the processor or processing function 31 and/or as a working storage of the processor or processing function 31. It is to be noted that the memory 34 may be implemented by using one or more memory portions of the same or different type of memory.

The processor or processing function 31 is configured to execute processing related to the above described control procedure. In particular, the processor or processing circuitry or function 31 includes one or more of the following sub-portions. Sub-portion 310 is a processing portion which is usable for determining a bearer. The portion 310 may be configured to perform processing according to S800 and S810 of FIG. 8. Furthermore, the processor or processing circuitry or function 31 may include a sub-portion 311 usable as a portion for providing an indication. The portion 311 may be configured to perform a processing according to S820 of FIG. 8. In addition, the processor or processing circuitry or function 31 may include a sub-portion 312 usable as a portion for executing a mobility control procedure. The portion 312 may be configured to perform a processing according to S830 of FIG. 8.

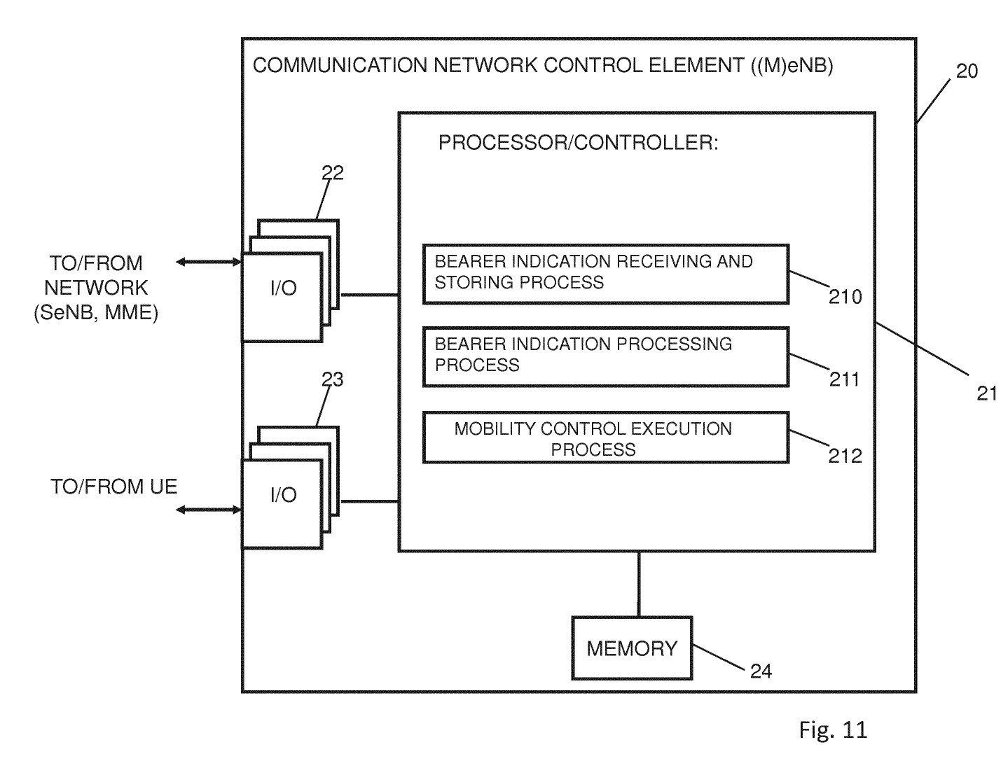

FIG. 11 shows a diagram of a communication network control element according to some examples of embodiments, which is configured to implement a control procedure as described in connection with some of the examples of embodiments. It is to be noted that the communication network control element, like the MeNB 20, which is shown in FIG. 11, may include further elements or functions besides those described herein below. Furthermore, even though reference is made to a communication network control element or node, the element or node may be also another device or function having a similar task, such as a chipset, a chip, a module, an application etc., which can also be part of a communication network control element or attached as a separate element to a communication network control element, or the like. It should be understood that each block and any combination thereof may be implemented by various means or their combinations, such as hardware, software, firmware, one or more processors and/or circuitry.

The communication network control element shown in FIG. 11 may include a processing circuitry, a processing function, a control unit or a processor 21, such as a CPU or the like, which is suitable for executing instructions given by programs or the like related to the control procedure. The processor 21 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 22 and 23 denote transceiver or input/output (I/O) units or functions (interfaces) connected to the processor or processing function 31. The I/O units 22 may be used for communicating with other network elements, such as the MME 30, the SeNB(s) 25, 26, and the like. The I/O units 23 may be used for communicating with a communication element, such as the UE 10, and the like. The I/O units 22 and 23 may be a combined unit including communication equipment towards several network elements, or may include a distributed structure with a plurality of different interfaces for different network elements. Reference sign 24 denotes a memory usable, for example, for storing data and programs to be executed by the processor or processing function 21 and/or as a working storage of the processor or processing function 21. It is to be noted that the memory 24 may be implemented by using one or more memory portions of the same or different type of memory.

The processor or processing function 21 is configured to execute processing related to the above described control procedure. In particular, the processor or processing circuitry or function 21 includes one or more of the following sub-portions. Sub-portion 210 is a processing portion which is usable for receiving and storing a bearer indication. The portion 210 may be configured to perform processing according to S900 of FIG. 9. Furthermore, the processor or processing circuitry or function 21 may include a sub-portion 211 usable as a portion for processing the bearer indication. The portion 211 may be configured to perform a processing according to S910 of FIG. 9. In addition, the processor or processing circuitry or function 21 may include a sub-portion 212 usable as a portion for executing a mobility control procedure. The portion 212 may be configured to perform a processing according to S920 of FIG. 9.

By means of the measures described above, a signaling procedure is provided which allows to use the prior knowledge of MME behavior related to offloading of bearers so that a redundant SCG-addition and SCG-release can be avoided in connection with a movement of traffic, such as Internet PDN connection, to the SeNB-LGW. A corresponding procedure is implementable, for example, during MeNB-SeNB mobility scenario and SeNB-SeNB mobility scenario.

Moreover, it is possible to provide an improved mobility control in dual connectivity operation mode in which a processing load is reduced due to reduced signaling requirements. For example, by using an early indication of the bearer (e.g. ERAB) characteristics in case of SIPTO offloading from the MME, the MeNB has to execute only a reduced number of signaling procedures to enable movement of the SIPTO bearer from core network to the LGW of an SeNB. Furthermore, with the control procedure according to some examples of embodiments, it is possible to reduce not only the signaling procedures, but it is also possible to reduce the amount of data forwarding and hence to avoid a loss due to this data-forwarding between MeNB and SeNB, for example.

It is to be noted that some or all of the examples of embodiments described above may be applied to a partly or fully virtualized environment comprising one or more VNFs.

According to another example of embodiments, there is provided an apparatus including means for determining whether a bearer to be set up and used for a communication connection of a communication element is a bearer eligible for selected traffic offloading to a local gateway of a cell group when the local gateway is available, and means for providing, in case the determination is affirmative, an indication in a signaling to a communication network control element of the communication element, the indication indicates that the bearer to be set up is a bearer eligible for selected traffic offloading as soon as a local gateway is available.

Furthermore, according to some other examples of embodiments, the above defined apparatus may further comprise means for conducting at least one of the processing defined in the above described methods, for example a method according that described in connection with FIG. 8.

According to another example of embodiments, there is provided an apparatus including means for receiving and storing, in case a bearer is to be set up and used for a communication connection of a communication element, an indication in a signaling from a management control element, wherein the indication indicates that the bearer to be set up is a bearer eligible for selected traffic offloading as soon as a local gateway is available, and means for processing the indication in a control procedure for controlling a movement of at least one bearer of the communication element from a source cell group to a target cell group.

Furthermore, according to some other examples of embodiments, the above defined apparatus may further comprise means for conducting at least one of the processing defined in the above described methods, for example a method according that described in connection with FIG. 9.

It should be appreciated that

an access technology via which traffic is transferred to and from a network element may be any suitable present or future technology, such as WLAN (Wireless Local Access Network), WiMAX (Worldwide Interoperability for Microwave Access), LTE, LTE-A, Bluetooth, Infrared, and the like may be used; additionally, embodiments may also apply wired technologies, e.g. IP based access technologies like cable networks or fixed lines.

a user device (also called UE, user equipment, user terminal, terminal device, etc.) illustrates one type of an apparatus to which resources on the air interface may be allocated and assigned, and thus any feature described herein with a user equipment may be implemented with a corresponding apparatus, such as a relay node. An example of such a relay node is a layer 3 relay (self-backhauling relay) towards a base station or eNB. The user device typically refers to a portable computing device that includes wireless mobile communication devices operating with or without a subscriber identification module (SIM), including, but not limited to, the following types of devices: a mobile station (mobile phone), smart phone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network, or a nearly exclusive downlink only device, such as a portable video player. Also equipment used for measuring certain values, such as sensors which can measure a temperature, a pressure etc., can be used as a corresponding user device. It should be appreciated that a device may be regarded as an apparatus or as an assembly of more than one apparatus, whether functionally in cooperation with each other or functionally independently of each other but in a same device housing.

embodiments suitable to be implemented as software code or portions of it and being run using a processor or processing function are software code independent and can be specified using any known or future developed programming language, such as a high-level programming language, such as objective-C, C, C++, C#, Java, Python, Javascript, other scripting languages etc., or a low-level programming language, such as a machine language, or an assembler.

implementation of embodiments is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), and/or TTL (Transistor-Transistor Logic).

embodiments may be implemented as individual devices, apparatuses, units, means or functions, or in a distributed fashion, for example, one or more processors or processing functions may be used or shared in the processing, or one or more processing sections or processing portions may be used and shared in the processing, wherein one physical processor or more than one physical processor may be used for implementing one or more processing portions dedicated to specific processing as described,

an apparatus may be implemented by a semiconductor chip, a chipset, or a (hardware) module including such chip or chipset;

embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components.

embodiments may also be implemented as computer program products, including a computer usable medium having a computer readable program code embodied therein, the computer readable program code adapted to execute a process as described in embodiments, wherein the computer usable medium may be a non-transitory medium.

Although the present invention has been described herein before with reference to particular embodiments thereof, the present invention is not limited thereto and various modifications can be made thereto.

1-30. (canceled)

31. An apparatus for dual connectivity, comprising
at least one processing circuitry,
and
at least one memory for storing instructions to be executed by the processing circuitry, wherein
the at least one memory and the instructions are configured to, with the at least one processing circuitry, cause the apparatus at least:
to determine whether a bearer to be set up and used for a communication connection of a user equipment is a bearer eligible for selected traffic offloading to a local gateway of a cell group when the local gateway is available, and
in case the determination is affirmative, to provide an indication in a signaling to a Master base station of the user equipment, the indication indicates that the bearer to be set up is a bearer eligible for selected traffic offloading as soon as a local gateway is available.

32. The apparatus according to claim 31, wherein the at least one memory and the instructions are further configured to, with the at least one processing circuitry, cause the apparatus at least:
to use, for determining whether the bearer is a bearer eligible for selected traffic offloading to the local gateway, subscriber information and policy information related to the user equipment requesting a bearer setup.

33. The apparatus according to claim 31, wherein the at least one memory and the instructions are further configured to, with the at least one processing circuitry, cause the apparatus at least:
to provide the indication in a bearer release signaling as a cause value informing that the bearer release is triggered for the selected traffic offloading or in a bearer setup signaling.

34. The apparatus according to claim 31, wherein the at least one memory and the instructions are further configured to, with the at least one processing circuitry, cause the apparatus at least:
to receive and process a bearer modification message including information about a target cell group and a local gateway included in the target cell group,
to determine whether there is only one bearer available for the user equipment,
in case the determination results that there is only one bearer available, to trigger a detach procedure for the user equipment for moving the bearer, and
to provide information related to a temporary mobile subscriber identity to the Master base station of the user equipment.

35. The apparatus according to claim 31, wherein the at least one memory and the instructions are further configured to, with the at least one processing circuitry, cause the apparatus at least:
to trigger, by initiating a packet data protocol context reactivation, an immediate offloading of the bearer eligible for selected traffic offloading when it is detected that a local gateway is available in a target cell group to which at least a part of a communication conducted by the user equipment is switchable.

36. The apparatus according to claim 31, wherein the at least one memory and the instructions are further configured to, with the at least one processing circuitry, cause the apparatus at least:
to receive and process a bearer modification message including information about a target cell group and a local gateway included in the target cell group, and
to trigger a bearer release by providing a signaling including a packet data protocol context deactivation instruction comprising a context reactivation indication,
wherein an information is included in the signaling, which indicates that the context reactivation is triggered for moving the bearer to the local gateway.

37. The apparatus according to claim 31, wherein the at least one memory and the instructions are further configured to, with the at least one processing circuitry, cause the apparatus at least:
to receive and process a signaling related to an activation of a packet data protocol context for a bearer eligible for selected traffic offloading to a local gateway, wherein the signaling includes address information of a target cell group,
to establish a connection to a base station associated to the target cell group for setting up a context with the local gateway of the target cell group, and
to receive and process a correlation identification element of the local gateway.

38. The apparatus according to claim 31, wherein the at least one memory and the instructions are further configured to, with the at least one processing circuitry, cause the apparatus at least:
to initiate a bearer setup to a target cell group by using a correlation identification element.

39. An apparatus for dual connectivity, comprising
at least one processing circuitry,
and
at least one memory for storing instructions to be executed by the processing circuitry, wherein the at least one memory and the instructions are configured to, with the at least one processing circuitry, cause the apparatus at least:
to receive and store, in case a bearer is to be set up and used for a communication connection of a user equipment, an indication in a signaling from a management control element, wherein the indication indicates that the bearer to be set up is a bearer eligible for selected traffic offloading as soon as a local gateway is available, and
to process the indication in a control procedure for controlling a movement of at least one bearer of the user equipment from a source cell group to a target cell group.

40. The apparatus according to claim 39, wherein the at least one memory and the instructions are further configured to, with the at least one processing circuitry, cause the apparatus at least:
to receive the indication in a bearer release signaling as a cause value informing that the bearer release is triggered for the selected traffic offloading or receive the indication in a bearer setup signaling.

41. The apparatus according to claim 39, wherein the at least one memory and the instructions are further configured to, with the at least one processing circuitry, cause the apparatus at least:
for processing the indication in the control procedure for controlling a movement of at least one bearer of the user equipment from the source cell group to the target cell group, to detect that the user equipment to which the bearer belongs is communicating with a target cell group supporting a local gateway being usable for selected traffic offloading, and
to determine that a bearer to be set up for the target cell group corresponds to the bearer for selected traffic offloading being indicated in the stored indication.

42. The apparatus according to claim 39, wherein the at least one memory and the instructions are further configured to, with the at least one processing circuitry, cause the apparatus at least:
to execute an addition procedure for adding the target cell group without bearer setup to the target cell group, and
to cause transmission to the management control element of a bearer modification message comprising information about the target cell group and the local gateway supported thereby.

43. The apparatus according to claim 39, wherein the at least one memory and the instructions are further configured to, with the at least one processing circuitry, cause the apparatus at least:
to receive and process a bearer release signaling including a packet data protocol context deactivation instruction comprising a context reactivation indication, wherein an information is included in the signaling, which indicates that the context reactivation is triggered for moving the bearer to the local gateway, and
to cause transmission of a message to the user equipment including information regarding the addition of the target cell group and the release of the bearer.

44. The apparatus according to claim 39, wherein the at least one memory and the instructions are further configured to, with the at least one processing circuitry, cause the apparatus at least:
to determine whether the target cell group without bearer setup is to be kept for a configured duration on the basis of the information included in the signaling.

45. The apparatus according to claim 39, wherein the at least one memory and the instructions are further configured to, with the at least one processing circuitry, cause the apparatus at least:
to cause transmission to the management control element of a bearer modification message indicating a need for a packed data protocol context reactivation, the message comprising information about an address of the local gateway supported by the target cell group.

46. The apparatus according to claim 39, wherein the at least one memory and the instructions are further configured to, with the at least one processing circuitry, cause the apparatus at least:
to receive and process a bearer release signaling including a packet data protocol context deactivation instruction comprising a context reactivation indication, wherein an information is included in the signaling, which indicates that the context reactivation is triggered for moving the bearer to the local gateway, and
to cause transmission of a message to the user equipment including information regarding the release of the bearer,
wherein a connection to the target cell group associated with a previous connection is kept.

47. The apparatus according to claim 39, wherein the at least one memory and the instructions are further configured to, with the at least one processing circuitry, cause the apparatus at least:
to release, in case both the target cell group and the source cell group are secondary cell groups with a local gateway, the bearer eligible for selected traffic offload at the source cell group when the target cell group is added.

48. The apparatus according to claim 39, wherein the at least one memory and the instructions are further configured to, with the at least one processing circuitry, cause the apparatus at least:
to cause transmission of a signaling related to an activation of a packet data protocol context for a bearer eligible for selected traffic offloading to a local gateway, wherein the signaling includes address information of the target cell group.

49. The apparatus according to claim 39, wherein the at least one memory and the instructions are further configured to, with the at least one processing circuitry, cause the apparatus at least:
to receive and process a bearer setup signaling for initiation of a setup of a bearer to the target cell group, the signaling including a correlation identification element of the local gateway,
to conduct a bearer setup procedure to the target cell group, wherein information including the correlation identification element are provided to the target cell group, and
to inform the user equipment about the addition of the bearer to the local gateway.

50. A method for dual connectivity including
receiving and storing, in a Master base station, in case a bearer is to be set up and used for a communication connection of a user equipment, an indication in a signaling from a management control element, wherein the indication indicates that the bearer to be set up is a bearer eligible for selected traffic offloading as soon as a local gateway is available, and
processing the indication in a control procedure for controlling a movement of at least one bearer of the user equipment from a source cell group to a target cell group.
